(19) United States
(12) Patent Application Publication
(10) Pub. No.: US 2009/0313575 A1
(43) Pub. Date: Dec. 17, 2009

(54) User interface and a method thereof

(76) Inventors: Markus Fister, Erlangen (DE); Pablo Munoz Ibarra, Erlangen (DE); Christian Prechtl, Koln (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/480,987

(22) Filed: Jun. 9, 2009

(30) Foreign Application Priority Data
Jun. 11, 2008 (EP) 08104362.2

(51) Int. Cl. G06F 3/048

(52) U.S. Cl. 715/781

(57) ABSTRACT

A user interface has a portal view with a first display region to display a first user selectable identifier representing a main function accomplishable within an engineering system. The portal view has a second display region to display a second user selectable identifier representing a subordinate function usable to accomplish the main function, the display of the second user selectable identifier being based on a first user selection of the first user selectable identifier. The portal view has an optional third display region to display a context-specific selection of project data, the display of the context-specific selection of the project data being based on a second user selection of the second user selectable identifier. The user interface has a project view with a fourth display region to display third user selectable identifiers. The portal view and the project view have a user selectable switching device for switching between the project view and the portal view.

### CROSS REFERENCE TO RELATED APPLICATIONS

This application claims priority of European Patent Application No. 08104362.2 EP filed Jun. 11, 2008, which is incorporated by reference herein in its entirety.

### FIELD OF INVENTION

The invention relates to a user interface for use in an industrial automation system.

### BACKGROUND OF INVENTION

In industrial automation systems, the processing and management of engineering project data has got a vital importance. The most common engineering systems used for this are complicated and difficult to learn. The visual representation of the project data tends to be comprehensive and complex. In complex engineering projects, an abundance of functionality, objects and object types are presented to the user. The user is quickly overwhelmed by this large amount of information and action alternatives.

In most engineering systems, project data is presented in the form of trees that usually are structured by object types (i.e. function-blocks, programs, variables, hardware-modules, watch-tables, alarms etc.). The user can invoke functions via selecting an object and choosing an entry in the main menu or toolbar of the application. Therefore the user must have knowledge on the containing object model or overall functionality that is available in the engineering project. He must act in accordance with an object model that is not necessarily suited to his mental model of the engineering process.

### SUMMARY OF INVENTION

An object of the present invention is to provide a more intuitive user interface for use in an industrial automation system.

This object is achieved by a user interface adapted for use in an industrial automation system, having:

a portal view, comprising:
a first display region adapted to display at least one first user selectable identifier representing at least one main function within an engineering system;
a second display region adapted to display at least one second user selectable identifier representing at least one subordinate function linked to the main function, the display of the second user selectable identifier being based on a first user selection of the first user selectable identifier;
a third display region adapted to display filtered project data, the display of the filtered project data being based on user selection of the main function and the subordinate function; and
a project view, comprising:
a fourth display region adapted to display third user selectable identifiers, the third user selectable identifiers representing the entire accessible project data, where the entire accessible project data is selectively accessible by selecting the third user selectable identifiers,
wherein the portal view and the project view comprise a user selectable switching means adapted for switching between the project view and the portal view.

This object is also achieved by a method for providing a user interface adapted for use in an industrial automation system, comprising the steps of:

in a portal view:
displaying in a first display region at least one first user selectable identifier representing at least one main function within an engineering system;
displaying in a second display region at least one second user selectable identifier representing at least one subordinate function, linked to the main function, the display of the second user selectable identifier being based on a first user selection of the first user selectable identifier;
displaying in a third display region a filtered project data, the display of the filtered project data being based on the main function and the subordinate function; in a project view:
in a fourth display region displaying third user selectable identifiers, the third user selectable identifiers representing the entire accessible project data, where the entire accessible project data is selectively accessible by selecting the third user selectable identifiers,
wherein the portal view and the project view comprise a user selectable switching means adapted for switching between the project view and the portal view.

The invention is based on the observation that in conventional engineering systems all functions are presented at the same time, for example in an application menu. Furthermore, this information is presented together with engineering data, for example in a project tree or even aggregated at the engineering objects as is the case with context menus. In the user interface presented herein, all the same information can be presented in a portal view, but in a hierarchical and progressively disclosing manner based on the main goals that need to be achieved in an engineering system. This supports a more intuitive user handling. Also the user is provided the facility to switch between the portal view and a full fledged project view which gives a conventional view on the project data. By selecting the third user selectable identifiers, the entire accessible project data is selectively accessible and can be displayed in the project view. This data is the filtered data based on the main function and the subordinate function. The invention gives a function based access to the engineering data, while retaining a data based access in a parallel conventional view.

In a preferred embodiment of the invention, the display of the at least one first user selectable identifier and the at least one second user selectable identifier is based on a user's expertise. This extends the interface to support certain user classes, for example beginner, expert, etc. This helps in presenting all necessary information in the engineering project while reducing it to the engineering content and functionality that is understandable to different category of users having different project experience levels.

In a further preferred embodiment of the invention, the display of the at least one first user selectable identifier and the at least one second user selectable identifier is based on a user's role. This extends the interface to support certain user roles, for example commissioner, administrator, programmer etc. This gives simplified access to complex project data and abundant engineering functionality based on what exactly a user having a specific role is supposed to deal with.

In another alternative embodiment the portal view further comprises an input selection area adapted for navigating to an additional context. This enables the user to navigate to a required location for performing a function instantly at any point in time from the current portal view.

### BRIEF DESCRIPTION OF THE DRAWINGS

The present invention is further described hereinafter with reference to preferred embodiments shown in the accompanying drawings, in which:

FIG. 1 is an exemplary illustration showing the user interface with portal view on engineering data,

FIG. 2 is an exemplary illustration showing the user interface with portal view on engineering data along with the provision to select an additional context, and

FIG. 3 is an exemplary illustration showing the user interface with project view on engineering data.

### DETAILED DESCRIPTION OF INVENTION

In accordance with psychological theories on action planning, actions are planned and executed with regard to certain goals. These goals can differ in dimension and time scale. Usually, actions are divided into operative sub-goals that have to be accomplished on the way to a larger final goal. Situations are apprehended and information is taken up with respect to the action-goal at hand. The proposed solution makes use of this knowledge on human behavior. The invention helps the user to accomplish his goals easily without the need to understand all possible action alternatives and project content. In engineering systems for industrial automation, these large scale goals are main functions to be accomplished, the sub-goals are subordinate functions that are used to accomplish the main function. The proposed user interface presents all necessary information in the engineering project while reducing it to the engineering content and functionality that is needed in a certain step.

In order to reduce complexity in the engineering process, commonly wizards are used to support a certain engineering step. However, these wizards oftentimes can only be executed once, do not serve the purpose to change data and constitute a modal dialog window where the user cannot interrupt his work until the wizard is finished. In comparison to a wizard, the invention provides an interruptible workflow and allows changing existing data.

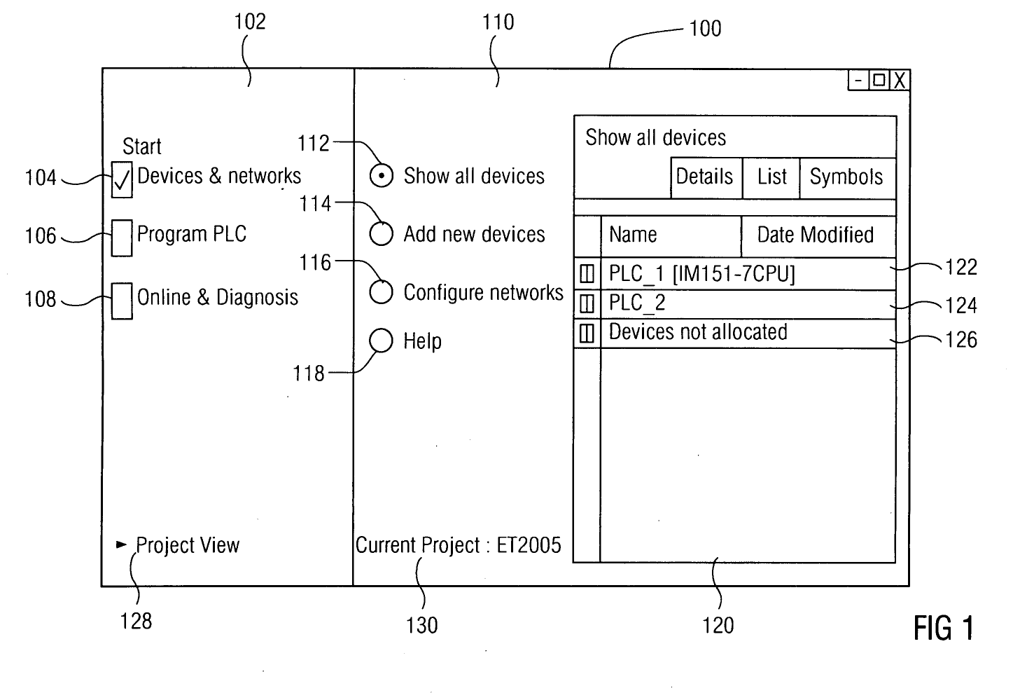

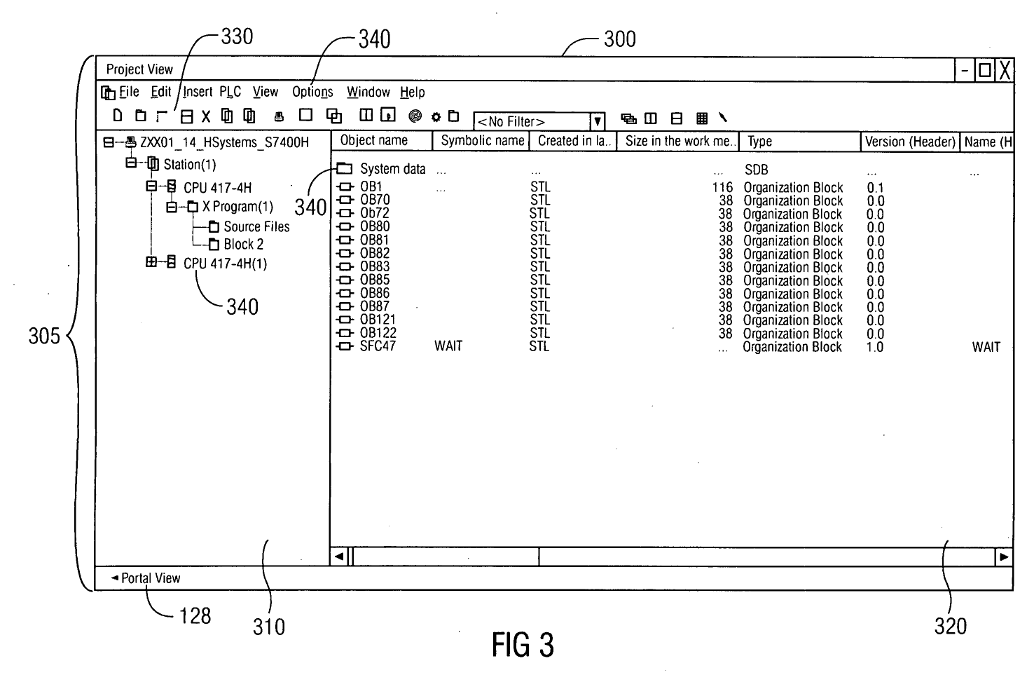

FIG. 1 is an exemplary illustration showing the user interface with portal view 100 on engineering data. The portal view 100 comprises a first display region 102 displaying user selectable identifiers 104, 106, 108 representing main functions accomplishable within an engineering system. The main function might be for example, to handle devices and networks, program a logic controller or diagnose an automation system online. The portal view 100 also comprises a second display region 110 displaying user selectable identifiers 112, 114, 116, 118 representing subordinate functions that are usable to accomplish the main function 104 related to devices and networks which has been selected in this case. In case of handling devices and networks the subordinate functions might be to get an overview of existing devices, to add new devices, to configure the network and an associated help function. The display of the subordinate functions depends on the selection of the main function. The main function and subordinate functions are hierarchically linked. The portal view 100 comprises an optional third display region 120 adaptable to display context-specific selection of project data 122, 124, 126. The display of this context-specific project data 122, 124, 126 is based on the user selection of the subordinate function, in this case the subordinate function identifier 112, to show all devices. The context-specific project data 122, 124, 126 in this case might be a list of existing devices, networks or other data contained in the engineering project. Engineering data is only presented at this point and filtered according to user's selection of the main function and the subordinate function. If no engineering data is needed for a certain action, for example when the user wants to get help or to connect with a device, the displaying of the context-specific project data might be omitted and as a result the third display 120 is not required. At any point in time the portal view 100 can be switched to a full fledged conventional project view 300 (as shown in FIG. 3) which can provide full functionality in parallel to the portal view 100. The portal view 100 and the project view 300 comprise a user selectable switching means 128 for switching between them. When complex information needs to be displayed for a certain engineering step, the view can be switched to a project view. The active current project is also displayed in the portal view using an identifier 130.

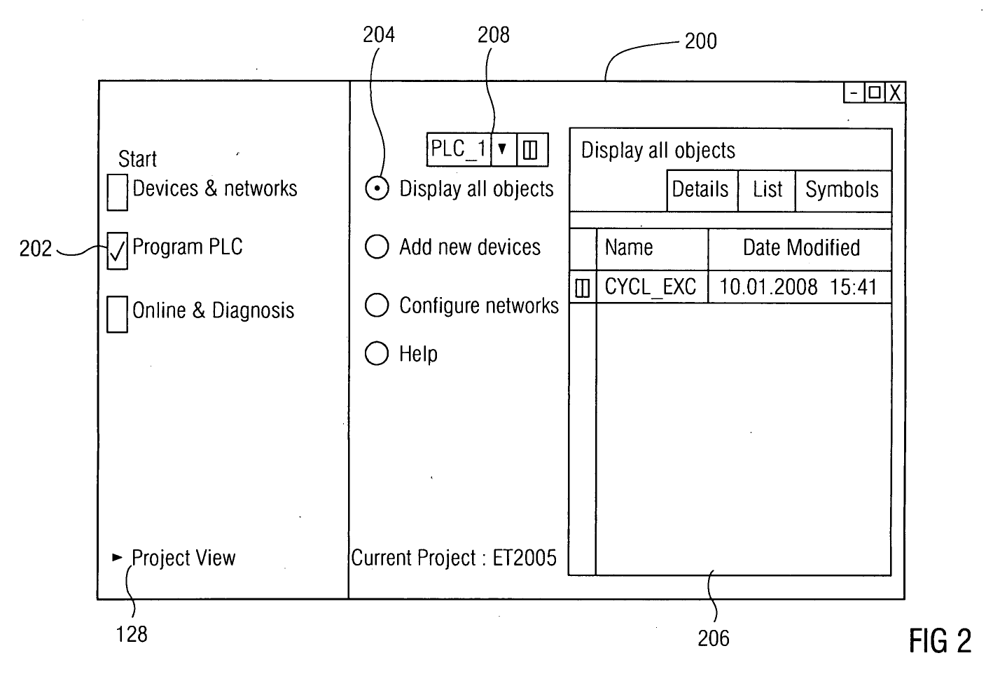

FIG. 2 is an exemplary illustration showing the user interface with portal view on engineering data along with the provision to select an additional context. The portal view 200 also gives a possibility to select an additional context, for example an engineering controller to work on. For this the portal view 200 further comprises an input selection area 208 for entering and selecting an additional context. Here a main function identifier 202 indicating a program PLC and a subordinate function identifier 204 indicating to display all objects which is associated with the main function is selected by the user resulting in a context-specific selection 206 of project data. The additional context can be a device or another super-ordinate object. For example, if the user's main function is to create a program block, the system needs to know on which device to create this block. The additional context helps in finding the system relevant information that is not available implicitly.

FIG. 3 is an exemplary illustration showing the user interface with a full fledged project view on engineering data. The project view 300 comprises a display region 305 having a plurality of control panes 310, 320, 330 comprising project information. The display region 305 displays plurality of user selectable identifiers 340, representing the entire accessible project data. By selecting the user selectable identifiers, the entire accessible project data is selectively accessible and can be displayed in the project view.

The user interface in the portal view substantially separates the presented project data from functionality, making the information less complex and understandable while still presenting all necessary information. The main function and the associated subordinate functions displayed in the portal view can be organized based on user's expertise. This extends the interface to support certain user classes, for example beginner, expert, etc. The same can be organized based on user roles. This extends the interface to support certain user roles, for example commissioner, administrator, programmer etc. This gives a simplified access to complex project data and abundant engineering functionality.

Summarizing, the invention relates to an improved user interface for use in an industrial automation system having a portal view 100, comprising a first display region 102 adapted to display at least one first user selectable identifier 104, 106, 108 representing at least one main function accomplishable within an engineering system. The portal view 100 comprises of a second display region 110 adapted to display at least one second user selectable identifier 112, 114, 116, 118 representing at least one subordinate function that is usable to accomplish the main function 104, the display of the second user selectable identifier being based on a first user selection of the first user selectable identifier. Further the portal view 100 comprises an optional third display region 120 adapted to display a context-specific selection of project data 122, 124, 126, the display of the context-specific selection of the project data 122, 124, 126 being based on a second user selection of the second user selectable identifier 112, 114, 116, 118. The user interface further has a project view 300 comprising a fourth display region 305 adapted to display third user selectable identifiers 340. The third user selectable identifiers 340 represent the entire accessible project data. Both the portal view 100, 200 and the project view 300 comprise a user selectable switching means for switching between the project view 300 and the portal view 100, 200.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the spirit or scope of the present invention as defined.

1.-8. (canceled)

9. A user interface for use in an industrial automation system, comprising:
a portal view, comprising:
a first display region adapted to display a first user selectable identifier representing a main function within an engineering system;
a second display region adapted to display a second user selectable identifier representing a subordinate function linked to the main fimetion, the display of the second user selectable identifier being based upon a first user selection of the first user selectable identifier;
a third display region adapted to display filtered project data, the display of the filtered project data being based upon user selection of the main function and the subordinate function; and
a project view, comprising:
a fourth display region adapted to display third user selectable identifiers, the third user selectable identifiers representing the entire accessible project data, the entire accessible project data being selectively accessible by selecting the third user selectable identifiers,
wherein the portal view and the project view comprise a user selectable switching device adapted for switching between the project view and the portal view.

10. The user interface according to claim 9, wherein the display of the first user selectable identifier and the second user selectable identifier are based upon a user's expertise.

11. The user interface according to claim 9, wherein the display of the first user selectable identifier and the second user selectable identifier are based upon a user's role.

12. The user interface according to claim 9, wherein the portal view further comprises an input selection area adapted for navigating to an additional context.

13. The user interface according to claim 10, wherein the portal view further comprises an input selection area adapted for navigating to an additional context.

14. The user interface according to claim 11, wherein the portal view further comprises an input selection area adapted for navigating to an additional context.

15. A method for providing a user interface adapted for use in an industrial automation system, comprising:
in a portal view:
displaying in a first display region a first user selectable identifier representing a main function within an engineering system;
displaying in a second display region a second user selectable identifier representing a subordinate function linked to the main function, the display of the second user selectable identifier being based upon a first user selection of the first user selectable identifier;
displaying in a third display region a filtered project data, the display of the filtered project data being based upon the main function and the subordinate function;
in a project view:
displaying in a fourth display region third user selectable identifiers, the third user selectable identifiers representing the entire accessible project data, the entire accessible project data being selectively accessible by selecting the third user selectable identifiers,
wherein the portal view and the project view comprise a user selectable switching device adapted for switching between the project view and the portal view.

16. The method according to claim 15, wherein the first user selectable identifier and the second user selectable identifier are displayed based on a user's expertise.

17. The method according to claim 15, wherein the first user selectable identifier and the second user selectable identifier are displayed based on a user's role.

18. The method according to claim 15, wherein the portal view further comprises an input selection area adapted for navigating to an additional context.

19. The method according to claim 16, wherein the portal view further comprises an input selection area adapted for navigating to an additional context.

20. The method according to claim 17, wherein the portal view further comprises an input selection area adapted for navigating to an additional context.
